(19) United States
(12) Patent Application Publication
(10) Pub. No.: US 2014/0318939 A1
(43) Pub. Date: Oct. 30, 2014

(54) SWITCH UNIT AND GAME MACHINE

(71) Applicant: OMRON CORPORATION, Kyoto-shi (JP)

(72) Inventors: Masataka Kimura, Aichi (JP); Hiroaki Sugiyama, Gifu (JP); Yoshihiko Takagi, Kyoto (JP); Yoshimasa Osumi, Kyoto (JP)

(73) Assignee: OMRON CORPORATION, Kyoto-shi (JP)

(21) Appl. No.: 14/228,006

(22) Filed: Mar. 27, 2014

(30) Foreign Application Priority Data
Apr. 26, 2013 (JP) 2013-094758

(51) Int. Cl. H01H 13/02

(52) U.S. Cl. CPC H01H 13/023
USPC 200/314

(57) ABSTRACT

A switch unit has an operation key, a cover member having an opening corresponding to the operation key, and a light emitting device disposed on a rear surface side of the cover member that makes the periphery of the operation key luminous by irradiation with light from a light emitting portion disposed on the periphery of the operation key. A top surface side of the operation key is inserted from the rear surface side of the cover member into the opening. An opposing-mirror portion is disposed on the cover member on at least a peripheral part of the operation key. The opposing-mirror portion has a half-mirror portion and a mirror portion spaced apart from the half-mirror portion with a space therebetween. The half-mirror portion is disposed above the mirror portion. The light emitting portion of the light emitting device faces the space between the half-mirror portion and the mirror portion.

### BACKGROUND

1. Field

The present invention relates to a switch unit, and especially relates to a switch unit provided with a display portion on the rear surface of a key, and a game machine loaded with the switch unit.

2. Related Art

In a slot machine being a kind of game machine, a plurality of reels displayed with a plurality of kinds symbols are spun, and when the reels are stopped, a combination is decided based on how symbols displayed in a window are aligned, or on the aligned symbols. A prize is given in accordance with the decided combination and the number of bets. A rotation of the reels is started by operation of a rotation-starting push button or lever provided on the slot machine. The reels are stopped automatically by control of an appliance as to a slot machine installed in a casino or the like.

Incidentally, a recreation facility such as a casino is installed not only with slot machines manufactured by a single game machine manufacturer, but also with slot machines manufactured by a variety of game machine manufacturers. The player selects a machine that matches his or her taste, out of the slot machines manufactured by the variety of game machine manufacturers, and plays a game. For this reason, in the recreation facility, a slot machine which is popular among players is installed, to seek to ensure superiority to other competitive recreation facilities. Therefore, the game machine manufacturers have been continuously developing slot machines that can appeal to players.

For example, Japanese Unexamined Patent Publication No. 2005-111137 describes a slot machine which is provided with a display portion configured by a touch panel, and displays a character or ten keys in the display portion, to allow instruction of setting the number of bets and starting a rotation of reels by means of the touch panel.

In the above conventional configuration, however, the player just touches the screen, and thus cannot be given an intuitive operational feeling, as compared with a push-button system. This will be described below.

In the push-button system, the player intuitively sets the number of bets by operation of pushing a push-button number of times corresponding to the number of bets to be set. However, in operation of touching the screen, it is necessary to check on the screen if the number of bets has been set by the touching at each time of operation. For this reason, the operational feeling is inferior to that in the conventional push-button system, and the intuitive operational feeling (e.g., clicking feeling) thus cannot be given. Further, with the number of bets checked at each time of setting, the time required for one game increases to cause reduction in speedy feeling and quick feeling.

In view of such a shortcoming, the present applicant has invented a switch unit with a configuration where a key that transmits an image of a display portion is disposed on the display portion via an elastic member and a lens that makes the image of the display portion look as if displayed on the operation surface of the operation keys is disposed between the display portion and the operation key (Japanese Unexamined Patent Publication No. 2012-200343).

According to this, it is possible not only to make the display portion perform a variety of displays, but also to obtain an intuitive operational feeling of pushing the key. Further, obtaining the intuitive operational feeling eliminates the need for checking a set content on the screen at each time of operation, and hence it possible to obtain the equivalent speedy feeling and quick feeling to those in the push-button system. Moreover, since the image of the display portion being on the rear surface of the key can be made to look as if displayed on the operation surface of the key, the visually felt operation surface agrees with the tactilely felt operation surface, and hence it is possible to perform operation with a feeling closer to that in the push-button system.

As described above, the image of the display portion being on the rear surface of the key can be made to look as if displayed on the operation surface of the key. However, the switch unit with the display portion provided on the rear surface of the key is flat and lacks a stereoscopic effect as compared with the conventional push-button system.

One or more embodiments of the present invention gives a stereoscopic effect in a switch unit provided with a display portion on the rear surface of the key. One or more embodiments combines the technique of making the switch unit look stereoscopic with a technique of floating an image of the display portion being on the rear surface of the key, and hence it is possible to further make the image look as if displayed on the operation surface of the key.

### SUMMARY

A switch unit according to one or more embodiments of the present invention is provided with: an operation key; a cover member which is provided with an opening corresponding to the operation key and in which the top surface side of the operation key is inserted from the rear surface side into the opening; and a light emitting device provided on the rear surface side of the cover member and configured to make the periphery of the operation key luminous by irradiation with light from a light emitting portion disposed on the periphery of the operation key, wherein an opposing-mirror portion is provided at least in a peripheral part of the operation key in the cover member, the opposing-mirror portion including a half-mirror portion disposed on the top surface side of the operation key, and a mirror portion disposed on the rear surface side thereof as spaced therefrom, the light emitting portion of the light emitting device faces a space between the half-mirror portion and the mirror portion in the opposing-mirror portion, and light emitted from the light emitting portion travels between the half-mirror portion and the mirror portion.

According to the above configuration, the light emitted from the light emitting portion travels while repeating reflection between the half-mirror portion and the mirror portion. During the traveling, part of the light which has reached the half-mirror portion is transmitted therethrough, and an operator views this transmitted light. An image formed by the light transmitted through the half-mirror portion has an identical shape in each place through which it is transmitted, and the intensity of the light becomes weaker as it travels farther from the light emitting portion.

The operator who has viewed an image of such light comes under a visual illusion. To the operator, it looks as if a plurality of bands of light (images of light) of the light emitting portion surrounding the periphery of the operation key are laminated while becoming thinner from the top surface side to the rear surface side of the operation key. In other words, it looks as if a plurality of stages of the light emitting portion surrounding the operation key are laminated in a height direction of the operation key. This leads to generation of a depth feeling on the periphery of the operation key and further to generation of a stereoscopic effect in the operation key, which can give a stereoscopic effect to the switch unit.

A switch unit according to one or more embodiments of the present invention may further be configured such that a transparent member is provided between the half-mirror portion and the mirror portion, and the light emitted from the light emitting portion travels inside the transparent member.

According to the above configuration, provision of the transparent member between the half-mirror portion and the mirror portion enhances strength of the opposing-mirror portion as compared with a configuration where the space between the half-mirror portion and the mirror portion is made up of an air layer.

A switch unit according to one or more embodiments of the present invention may further be configured such that a display portion is provided on the rear surface side of the operation key, the operation key is provided with an image see-through portion configured to transmit the image of the display portion therethrough, and the image see-through portion has a lens function of making the image of the display portion look as if displayed on the top surface of the operation key.

According to the above configuration, the image see-through portion can bring the operator under a visual illusion and float the image of the display portion to make it look as if displayed on the top surface of the operation key. Furthermore, in the above configuration, the depth feeling has also been generated in the operation key due to the illusion generated by the opposing-mirror portion, and hence the depth feeling in the operation key cancels the insufficiency of a floating feeling of the image, making it possible to further make a user feel as if the image is on the top surface or in the vicinity of the top surface of the operation key.

According to one or more embodiments of the present invention, a game machine is mounted with a switch unit according to one or more embodiments of the present invention.

According to one or more embodiments of the present invention, in a switch unit where a display portion is provided on the rear surface of a key, it is possible to give a stereoscopic effect, and the combination between this technique of making the switch unit look stereoscopic and a technique of floating an image of the display portion being on the rear surface of the key further exerts the effect of making the image look as if displayed on the operation surface of the key.

### BRIEF DESCRIPTION OF THE DRAWINGS

FIGS. 1A and 1B are sectional views of a switch unit of a first embodiment of the present invention;

FIG. 2 is a plan view of the switch unit of the first embodiment;

FIGS. 3A and 3B are views each explaining the reason why an image looks floating on the surface of the operation key in the switch unit of the first embodiment;

FIGS. 4A and 4B are views each explaining the reason why an image looks floating on the surface of the operation key in the switch unit of the first embodiment;

FIGS. 5A and 5B are views explaining a visual difference between the case where the periphery of the operation key is not made luminous and the case where the periphery is made luminous in the switch unit of the first embodiment;

FIG. 6 is a view explaining the reason why the operation key looks stereoscopic in the switch unit of the first embodiment;

FIG. 7 is a view showing a result of simulating a light traveling status in a structure of the switch unit of the first embodiment;

FIGS. 8A and 8B are sectional views of an operation key of a modified example in the switch unit of the first embodiment;

FIGS. 9A and 9B are sectional views of a switch unit of a second embodiment of the present invention;

FIG. 10 is a view showing a result of simulating a light traveling status in a structure of the switch unit of the second embodiment;

FIG. 11 is a general perspective view of a slot machine provided with a switch unit of a third embodiment;

FIG. 12 is a plan view of the switch unit of the third embodiment;

FIG. 13 is a sectional view of the switch unit of the third embodiment; and

FIG. 14 is an exploded perspective view of the switch unit of the third embodiment.

### DETAILED DESCRIPTION

Hereinafter, embodiments of the present invention will be described with reference to the attached drawings. However, the present invention is not restricted to the following embodiments, but a variety of design modifications can be made in a range without deviating from the gist of the present invention. In embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

### First Embodiment

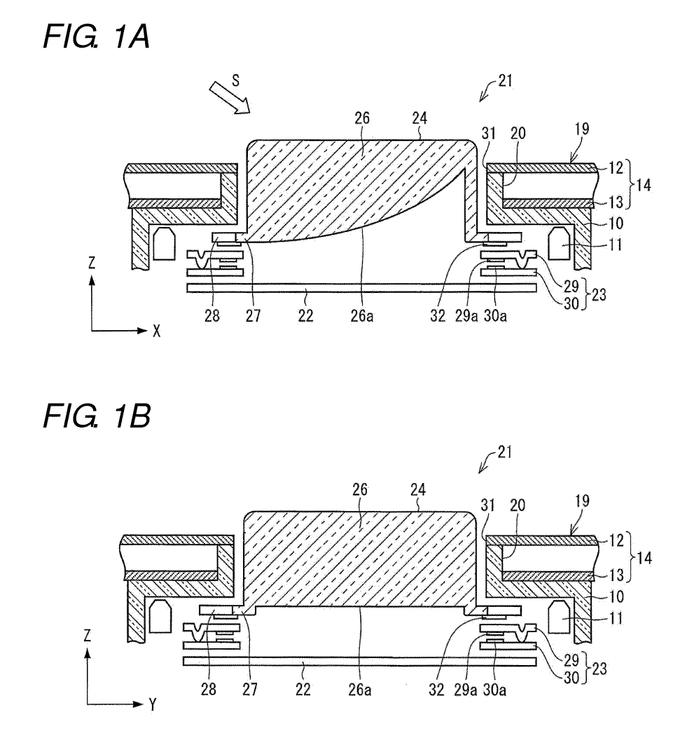

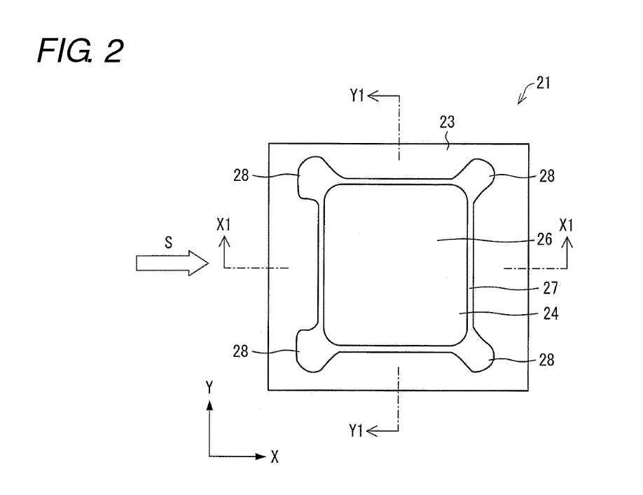

Hereinafter, a switch unit 21 according to a first embodiment of the present invention will be described with reference to FIGS. 1A to 8. FIGS. 1A and 1B are both sectional views of the switch unit 21 of the first embodiment. More specifically, FIG. 1A is a sectional view along a line X1-X1 of FIG. 2, and FIG. 1B is a sectional view along a line Y1-Y1 of FIG. 2. FIG. 2 is a plan view of the switch unit 21 of the first embodiment. However, in FIG. 2, an operation key cover denoted by numeral 19 in FIGS. 1A-B is omitted. It is to be noted that directions “top”, “bottom”, “left” and “right” used hereinafter are one merely to show directions on the drawings, and are not intended to restrict a posture of the switch unit when it is installed.

As shown in FIGS. 1A and 1B, the switch unit 21 is formed by superimposing a sheet switch 23 on an image display portion 22, placing an operation key 24 thereon, and further superimposing the operation key cover 19. The image display portion 22 displays display information such as a letter or a pattern in a region opposed to the operation key 24.

According to one or more embodiments of the present invention, an image display portion 22 is an electronic display device such as a liquid crystal display (LCD) or an organic EL, but it may be a simple printed matter. When the image display portion 22 is an electronic display device, an image thereof can be electrically changed. When the image display portion 22 is a printed matter, an image can be changed by replacing the printed matter.

As shown in FIG. 2, the operation key 24 is formed by extending a flange 27 in a lower part of the outer peripheral surface of an image see-through portion 26 in a quadrangular prism shape, and further making a leg piece 28 protrude from each of four corners thereof in a diagonal direction. The operation key 24 is injection-molded of a transparent or semitransparent polycarbonate resin, polymethyl methacrylate (PMMA) resin, or the like. According to one or more embodiments of the present invention, the operation key 24 is one molded of a transparent resin, but may be one molded of a semitransparent resin with high transparency, or of a lightly colored semitransparent resin.

The image see-through portion 26 has a lens function of making the image of the image display portion 22 look as if displayed on the top surface of the operation key 24, and the top surface (key top) of the image see-through portion 26 is a flat surface or a slightly swollen spherical surface. In each of FIGS. 1A and 2, an arrow S shows a direction of a visual line of a person (operator) who operates the operation key 24, in viewing the operation key 24. A rear surface 26a of the image see-through portion 26 is a curved inclined surface, and as shown in FIG. 1A, from the side closer to the operator to the farther side therefrom, the rear surface 26a is inclined toward the top surface side of the image see-through portion 26. In the switch unit 21 of the first embodiment, the rear surface 26a (inclined surface) of the image see-through portion 26 is a curved surface having the shape of a single semicircular-arc sectional cylindrical lens or a compound semicircular-arc sectional cylindrical lens. Within a Z-X plane, the rear surface 26a is curved so as to be swollen to the rear surface side as in FIG. 1A, and within a Y-Z plane, the rear surface 26a is linear as in FIG. 1B.

The rear surface 26a of the image see-through portion 26 shown in FIG. 1A has the shape of the compound semicircular-arc sectional cylindrical lens with a radius of curvature changing so as to be gradually reduced from the side closer to the operator to the farther side therefrom, but the shape of the compound semicircular-arc sectional cylindrical lens can be changed in each divided part. For example, the rear surface 26a may be divided into a region closer to the operator and a region farther therefrom, and may have a fixed and relatively large curvature in the region closer to the operator while having a fixed and relatively small curvature in the region farther from the operator. Further, the rear surface 26a of the image see-through portion 26 may have a semicircular-arc sectional surface with a fixed radius of curvature (shape of a single semicircular-arc sectional cylindrical lens). It is to be noted that in the present specification, a Z-axis is set in a vertical direction to the top surface of the operation key 24, an X-axis is set in a direction orthogonal to the Z-axis within the surface including the direction of the visual line of the operator and the Z-axis, and a Y-axis is set in a direction orthogonal to the Z-axis and the X-axis.

An operation key cover (cover member) 19 is a cover that covers the side where the operation key 24 is disposed in the switch unit 21, and has an opening 31 for insertion of the image see-through portion 26. The operation key 24 is vertically slidably inserted into the opening 31 of the operation key cover 19 from the lower part of the image see-through portion 26. A light guiding portion 10, disposed along the edge of the opening 31, is located above the flange 27 to regulate the operation key 24 not to pass through upward.

The light guiding portion 10 serves to make the periphery of the operation key 24 luminous and is disposed so as to surround the periphery of the operation key 24. A light sauce 11 is disposed in the vicinity of the light guiding portion 10, and light of the light sauce 11 is inputted into the light guiding portion 10. The light guiding portion 10 and the light sauce 11 constitute a light performance device (light emitting device) for decorating the periphery of the operation key 24. The light introduced into the light guiding portion 10 propagates inside the light guiding portion 10 and is discharged from a diffusion portion 20, to make the periphery of the operation key 24 luminous. The portion formed with the diffusion portion 20 is the light emitting portion.

In the switch unit 21 of the first embodiment, an opposing-mirror portion 14 is arranged in a region around the opening 31 in the operation key cover 19. The opposing-mirror portion 14 has a half-mirror (half-mirror portion) 12 and a mirror (mirror portion) 13 which are spaced from each other, and the half-mirror 12 is disposed on the top surface side of the operation key 24. The diffusion portion 20 is provided in a part facing the space between the half-mirror 12 and the mirror 13 in the light guiding portion 10, and light is emitted to the space. It is to be noted that the entire flat part formed with the opening 31 in the operation key cover 19 may be configured by the opposing-mirror portion 14. Further, each of the half-mirror 12 and the mirror 13 is usually formed by depositing a mirror material on a transparent base material such as glass, whereby one surface is the mirror surface or the half-mirror surface and the other surface is the transparent base material surface. Considering separation of the mirror material and the like, according to one or more embodiments of the present invention, the half-mirror 12 to be located on the outer surface of the switch unit 21 is disposed such that the transparent base material side is located on the outer surface.

The sheet switch 23 is formed by superimposing an upper substrate 29 and a lower substrate 30 on each other. The upper substrate 29 and the lower substrate 30 are provided with contacts 29a and 30a on the surfaces opposed to each other immediately below the leg piece 28 of the operation key 24. The upper substrate 29 and the lower substrate 30 are respectively formed with wiring (not shown) conducted to the contacts 29a and 30a. Further, the lower surface of the leg piece 28 is provided with a protrusion 32 for pushing the sheet switch 23 to bring the contacts 29a and 30a into contact with each other.

The upper substrate 29 is formed of a material having flexibility and elasticity, such as silicon rubber, and irregular ribs are formed on the upper substrate 29. The lower substrate 30 is formed of a print wiring substrate or the like. The contact 29a of the upper substrate 29 is floated from the contact 30a by the rib of the upper substrate 29 coming into contact with the lower substrate 30, and in a normal state, the contacts 29a and 30a are held in an insulating state. Further, the operation key 24 is mounted on the upper substrate 29 such that each leg piece 28 is located immediately above the contacts 29a and 30a.

In the switch unit 21 as described above, since the image see-through portion 26 is formed of the transparent or semitransparent material, the operator can recognize display information (e.g. display of the kind, function and the like of the switch) of the image display portion 22 through the image see-through portion 26. When the operator pushes the key top of the operation key 24, the contact 29a is pushed by the leg piece 28 to come into contact with the contact 30a and turn the sheet switch 23 on, leading to detection that the operation key 24 has been pushed. Further, when the operator releases the operation key 24, the contact 29a is separated from the contact 30a due to elastic return force of the upper substrate 29, to turn the sheet switch 23 off. Simultaneously, the operation key 24 is pushed up due to the elastic return force of the upper substrate 29, to be returned to the original place.

Further, according to this switch unit 21, since the shape of the image see-through portion 26 in the operation key 24 is devised as described above, it is possible, by making the operator have a visual illusion (optical illusion), to float the image of the display information displayed in the image display portion 22, so as to make a user feel as if the image is on the top surface (key top) or in the vicinity of the top surface of the operation key 24.

Further, according to this switch unit 21, since the opposing-mirror portion 14 is disposed in the peripheral part of the operation key 24, it is possible, by making the operator have a visual illusion, to generate a depth feeling (stereoscopic effect) on the periphery of the operation key 24, so as to make a user feel as if the top surface part of the operation key 24 protrudes from the front (top surface side). Moreover, by making a user as if the top surface part of the operation key 24 protrudes, it is possible to further make a user feel as if the image is on the top surface or in the vicinity of the top surface of the operation key 24 (resolving a lack of floating feeling of an image).

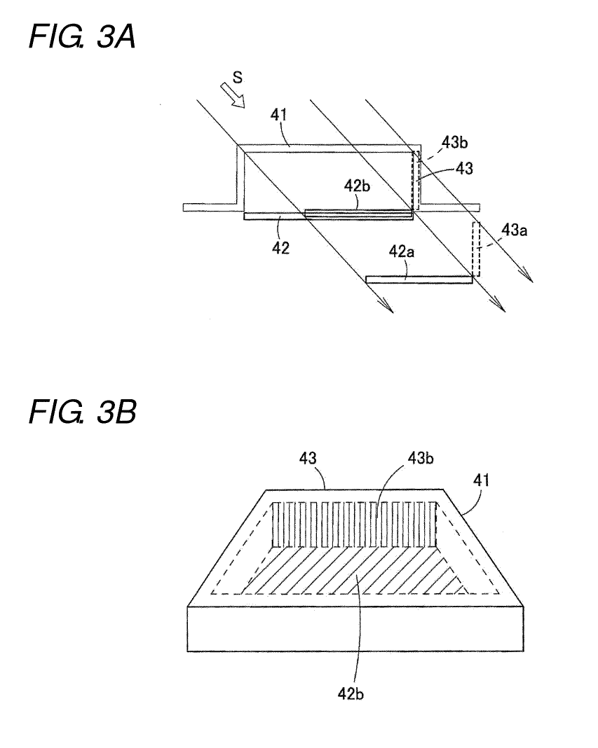

Hereinafter, there will be described the reason why the image looks floating and the reason why the operation key 24 looks stereoscopic with reference to FIGS. 3 to 7. It is to be noted that in the following description, an image forming position is not considered.

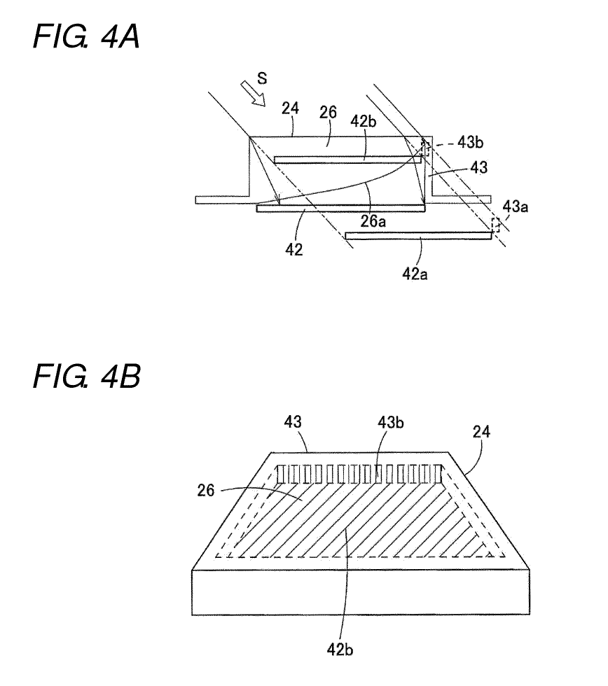

First, the reason why the image looks floating will be described with reference to FIGS. 3 and 4. FIGS. 3A and 3B show an operation key 41 of a comparative example, and a box-shaped operation key having a recess on the rear surface thereof. When display information 42 is viewed through such an operation key 41, as shown in FIG. 3A, an image 42a viewed through the operation key 41 is part of the display information 42 since part of the display information 42 is blocked by a side wall (outer peripheral surface) on the operator's side. Further, an image of a side wall 43 on the farther side from the operator is an image 43a indicated by a broken line. Hence the images viewed through the operation key 41 are the images 42a and 43a (an image forming position is not considered).

In the case of a person recognizing a position of a matter, he or she makes rational determination by not only depending on a feeling of distance in a visual sense, but also adopting other auxiliary information. In the case of FIG. 3A, since the side wall 43 is immediately below the top surface of the operation key 41, it is determined (due to an illusion) that the image 43a of the side wall 43 is also immediately below the top surface of the operation key 41. That is, it is unconsciously determined that the image of the side wall 43 is located in a position of the image 43b of FIG. 3A. Accordingly, it is determined that the image of the display information 42 is also located in a position of an image 42b of FIG. 3A. As a result, in the case of using such an operation key 41, as represented in FIG. 3B, the position of the image 42b of the display information 42 is hardly different from the original position of the display information 42, and the image 42b is recognized as if being located in quite a deeper position from the top surface of the operation key 41.

FIGS. 4A and 4B show the case of using the operation key 24 mounted in the switch unit 21 of the first embodiment. In the case of viewing through the operation key 24, as shown in FIG. 4A, the image 43a of the side wall 43 on the farther side from the operator is much smaller than a height of the side wall 43 due to the lens function of the image see-through portion 26. Therefore, when it is determined that this image 43a is below the top surface of the operation key 24 as in the image 43b of FIG. 4A, accordingly, the image of the display information 42 is recognized as being located in a position of the image 42b of FIG. 4A. Hence in the case of using such an operation key 24, the position of the image 42b gets quite closer to the top surface of the operation key 24 as shown in FIG. 4B. Hence the distance from the top surface of the operation key 24 to the image 42b becomes shorter, thereby significantly improving the depth feeling of the image 42b of the display information 42 viewed through the operation key 24.

It is to be noted that the shape of the operation key, which is capable of floating an image of display information displayed in the image display portion 22 to make a user as if the image is on the top surface (key top) or close to the top surface, is not restricted to the shape of the operation key 24, but can be subjected to a variety of changes.

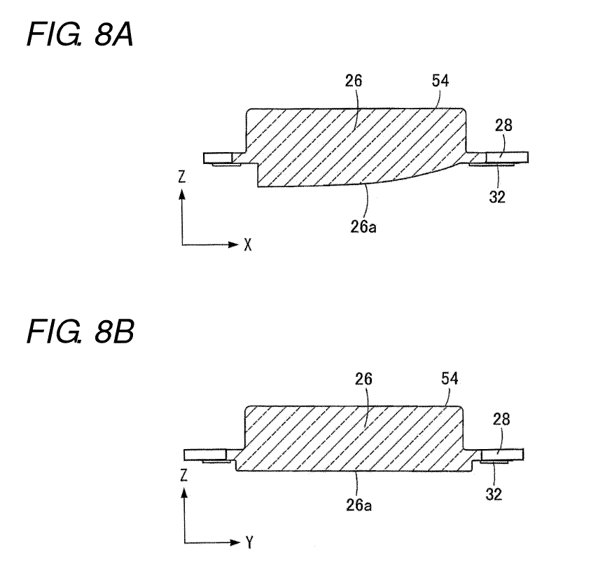

For example, FIGS. 8A-B show a sectional view of an operation key 54 of a modified example. FIG. 8A shows a cross section parallel to a Z-X plane, and FIG. 8B shows a cross section parallel to a Y-Z plane. In this operation key 54, the rear surface 26a of the image see-through portion 26 protrudes downward from the lower surface of the leg piece 28. When the rear surface 26a of the image see-through portion 26 is protruded downward from the lower surface of the leg piece 28 as thus described, the effect of floating the image to the vicinity of the top surface of the image see-through portion 26 is enhanced as compared with the operation key 24 with the rear surface 26a recessed upward than the lower surface of the leg piece 28. Further, although the rear surface 26a is the inclined curved surface in each of the operation keys 24, 54, it may be an inclined flat surface. However, the effect of floating the image to the vicinity of the top surface of the image see-through portion 26 is inferior as compared with that of the curved surface.

Further, although not shown, such a structure may be formed that the rear surface of the image see-through portion 26 is made a flat surface parallel to the top surface, and the outer peripheral surface (side wall) of the image see-through portion 26 is inclined so as to get inward from the rear surface to the top surface of the image see-through portion 26. According to one or more embodiments of the present invention, in inclining the outer peripheral surface, the inclination of each side surface measured from the axis along a normal of the top surface of the operation key is set such that, when the inclination of the side wall on the closer side to the operator is P and the inclination of the side wall on the farther side from the operator is Q, the inclinations P, Q are P≦Q. The inclination of the side wall on the closer side to the operator is made not larger than the inclination of the other side wall because, when the inclination of the side wall on the closer side to the operator is made too large, light that leaks from the side wall in a direction toward the operator becomes large in amount.

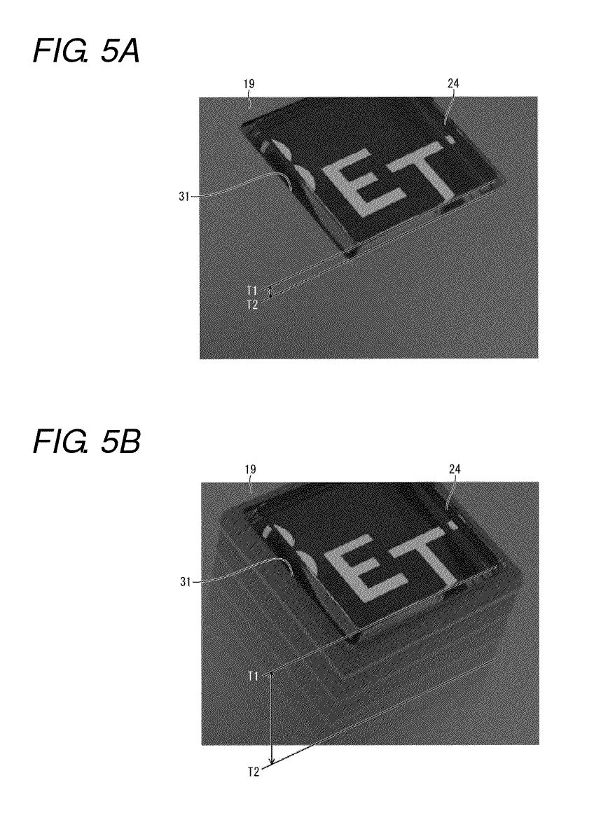

Next, the reason why the operation key 24 looks stereoscopic will be described with reference to FIGS. 5 to 7. FIGS. 5A and 5B represent visual comparison in the switch unit 21 between the case of not making the periphery of the operation key 24 luminous and the case of making it luminous. FIG. 5A is a situation where display information of the image display portion 22 is viewed in the state of not making the periphery of the operation key 24 luminous. FIG. 5B is a situation where display information of the image display portion 22 is viewed in the state of making the periphery of the operation key 24 luminous. As shown in FIG. 5B, when the periphery of the operation key 24 is made luminous, it looks as if a plurality of bands of light (images of light) surrounding the periphery of the operation key 24 are laminated while becoming thinner from the top surface side to the rear surface side of the operation key 24. When FIGS. 5A and 5B are compared, in the case of making the periphery of the operation key 24 luminous (FIG. 5B), a depth feeling of the operation key 24 (feeling of distance between T1 and T2) is generated and the top surface part of the operation key 24 looks stereoscopic as if protruding to the front (top surface side). Additionally, in the case of making the periphery of the operation key 24 luminous (FIG. 5B), due to the operation key 24 looking stereoscopic as above, the image of the display information looks as if being reflected in the vicinity of the top surface of the image see-through portion 26.

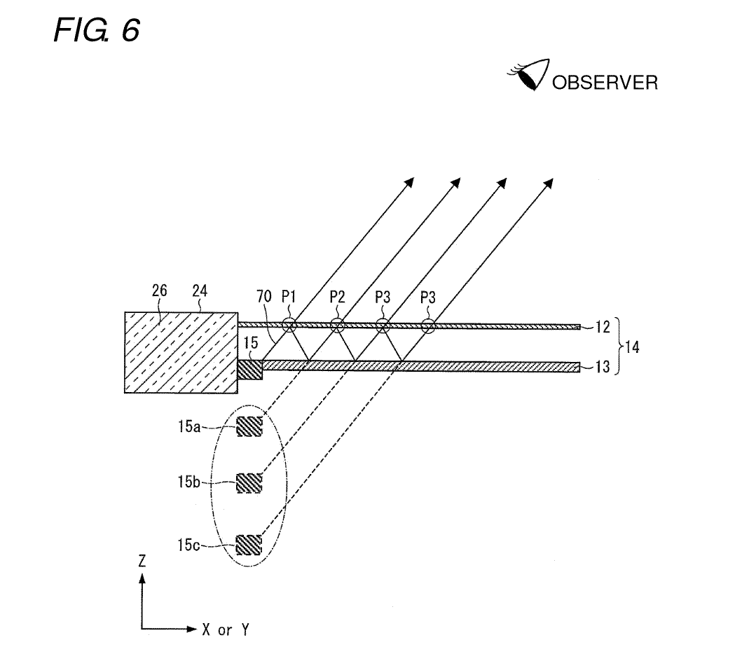

FIG. 6 is a view for explaining a principle that the depth feeling is generated in the switch unit 21 by disposing the opposing-mirror portion 14 on the periphery of the operation key 24. In FIG. 6, assuming that light 70, which travels in a direction into eyes of an observer out of light emitted from a light emitting portion 15 provided on the periphery of the operation key 24, has a light transmittance of 50% through the half-mirror 12, the half of the light is first totally reflected at a point P1 where the light has reached the half-mirror 12, and another half thereof is transmitted through the half-mirror 12 to reach the observer. The light reflected at the point P1 is totally reflected on the mirror 13, and again, the half of the light is further totally reflected at a point P2 where the light has reached the half-mirror 12, to return, and another half thereof is transmitted through the half-mirror 12 to reach the observer. The light 70 travels between the half-mirror 12 and the mirror 13 while repeating partial transmission trough the half-mirror 12 and total reflection on the mirror 13. Further, the intensity of the light becomes low as the number of times of the light reaching the half-mirror 12 increases (as the light travels farther from the operation key 24), and the light becomes unviewable by the operator.

A person has an illusion that light goes straight ahead. For this reason, the person views light, transmitted through the points P2 to P4 arrayed in the X-axis direction and the Y-axis direction, by projecting it in the Z-axis direction, which makes light emitting portion images 15a to 15c look as if arrayed along with the light emitting portion 15 in the Z-axis direction. Furthermore, since the intensity of light reaching the eyes becomes lower as the light travels farther from the operation key 24, appearances of the light emitting portion 15 and the light emitting portion images 15a to 15c are added with gradation which becomes thinner as getting farther from the top surface of the operation key 24, and a user feels a more depth. In other words, the light emitting portion images 15a to 15c look as if a plurality of stages of the light emitting portion surrounding the operation key 24 are laminated in the height direction of the operation key 24. This leads to generation of a depth feeling on the periphery of the operation key 24 and further to generation of a stereoscopic effect in the operation key 24, which can give a stereoscopic effect to the switch unit 21.

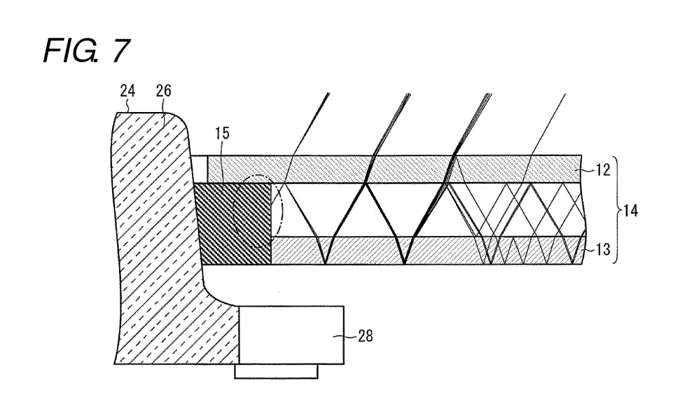

FIG. 7 shows a result of simulating a light traveling status in a structure of the switch unit 21. The light emitting portion 15 corresponds to a part where the diffusion portion 20 of the light guiding portion 10 is provided in FIG. 1A. Light is emitted from the entire surface of the light emitting portion 15 and travels in all directions. FIG. 7 represents a travelling manner of only light outputted from one light output point and getting into specific eyes out of total light rays. In the configuration of the switch unit 21, a part in the light emitting portion 15 is surrounded by a dashed line and can be repeatedly viewed. In addition, the mirror surface of the mirror 13 may be the side in contact with the air layer.

### Second Embodiment

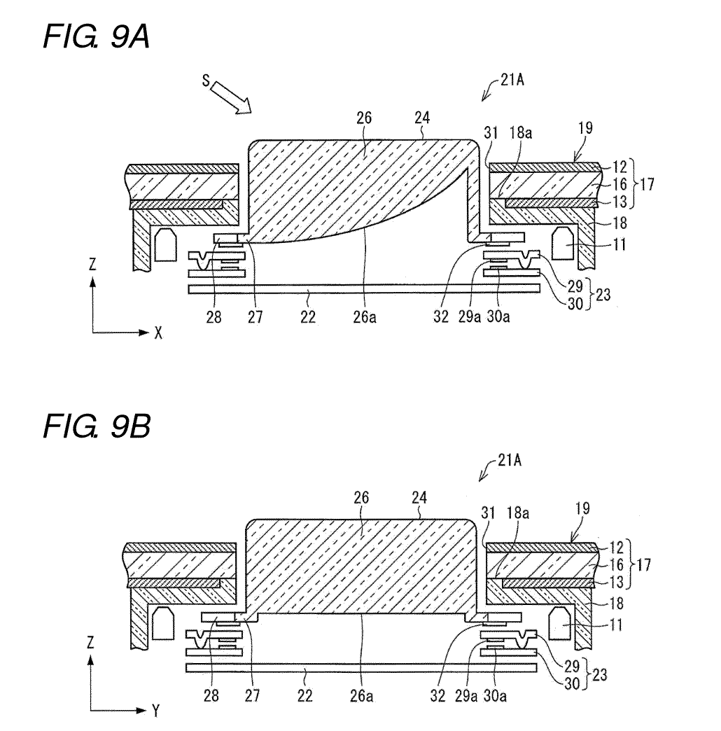

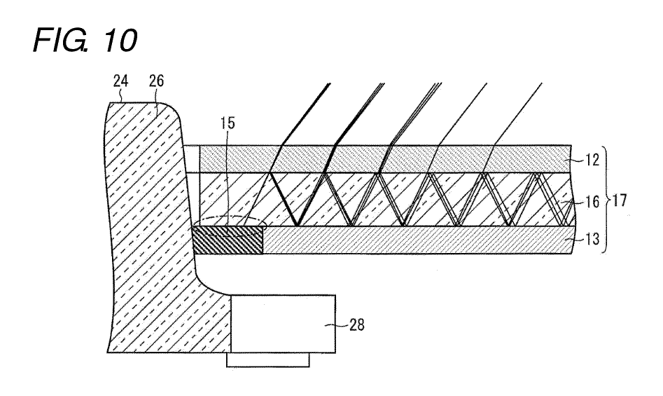

A second embodiment of the present invention will be described using FIGS. 9 and 10. It is to be noted that for convenience of description, members having similar functions as in the first embodiment are provided with the same reference number and a description thereof will be omitted. FIGS. 9A and 9B are both sectional views of a switch unit 21A of the second embodiment. More specifically, FIG. 9A is a sectional view corresponding to FIG. 1A, and FIG. 9B is a sectional view corresponding to FIG. 1B.

A difference between the switch unit 21A of the second embodiment and the switch unit 21 of the first embodiment (cf. FIG. 1A-B) lies in a structure of the opposing-mirror portion provided in the operation key cover 19. The half-mirror 12 and the mirror 13 are disposed as spaced from each other in the opposing-mirror portion 14, whereas the half-mirror 12 and the mirror 13 are separated from each other via a transparent member 16 in an opposing-mirror portion 17. That is, light passes through the inside of the transparent member 16 when travelling between the half-mirror 12 and the mirror 13. Providing such a transparent member 16 in place of the air layer can enhance the strength of the operation key cover 19, to strengthen the switch unit 21A.

Further, in the configuration of the switch unit 21A, a light guiding member 18 is not formed so as to cover the opening 31 formed in the operation key cover 19, but formed with an end surface 18a of the light guiding member 18 being in contact with the transparent member 16. The end surface 18a is not subjected to mirror processing, and light guided from the light sauce 11 into the light guiding member 18 can be outputted. That is, the end surface 18a is the light emitting portion.

FIG. 10 shows a result of simulating a light traveling status in a structure of the switch unit 21A. In FIG. 9A, the light emitting portion 15 corresponds to the part of the end surface 18a of the light guiding member 18 not subjected to mirror processing. Light is emitted from the entire surface of the light emitting portion 15 and travels in all directions. FIG. 10 represents a travelling manner of only light outputted from one light output point and getting into a specific eyes out of total light rays. In the configuration of the switch unit 21A, a part in the light emitting portion 15 is surrounded by a dashed line and can be repeatedly viewed. It is to be noted that, although the mirror surface of the mirror 13 is on the transparent member 16 side in the example of FIG. 10, the transparent base material surface of the mirror 13 may be on the transparent member 16 side. In this case, the transparent base material of the mirror 13 and the transparent member 16 can be configured by one transparent member, to integrate the mirror 13 and the transparent member 16.

### Third Embodiment

A switch unit according to one or more embodiments of the present invention can be used as a switch panel for a variety of game machines, industrial appliances, consumer appliances and the like. With reference to a third embodiment, a slot machine (game machine) provided with the switch unit according to one or more embodiments of the present invention will be described below.

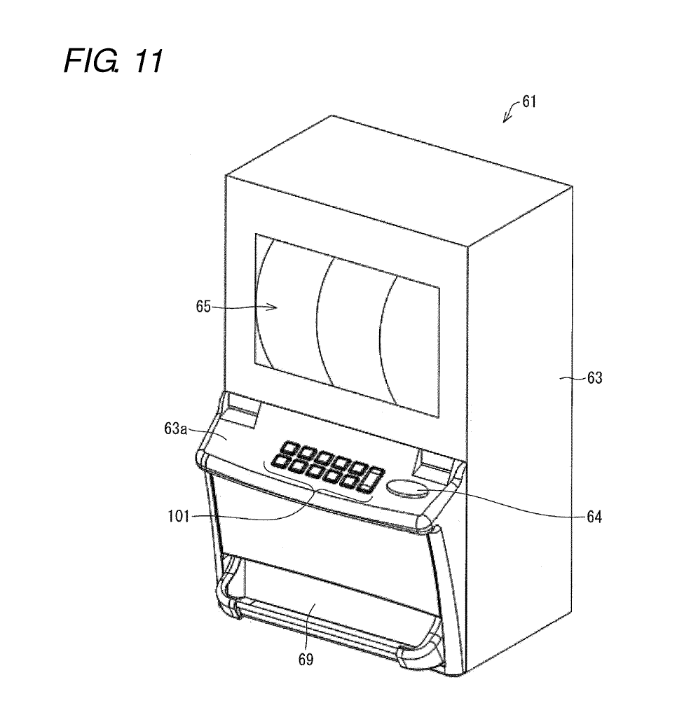

FIG. 11 is a general perspective view of a slot machine 61 provided with a switch unit 101. In the slot machine 61, a reel portion 65 is provided in the central portion of the front surface facing a player (operator). The reel portion 65 is provided with a plurality of reels (not shown) where a plurality of kinds of symbols are displayed. A rotation of the plurality of reels is started by the player operating a reel rotation button 64 provided below the reel portion 65, and the rotation is automatically stopped by control of the appliance. When the reels are stopped, a combination is decided based on how symbols displayed in a window of the reel portion 65 are aligned, or on the aligned symbols, and the player is given a prize in accordance with the decided combination and the number of bets. The number of bets are set by use of the switch unit 101 provided side by side with the reel rotation button 64. Below the switch unit 101, a tray 69 is provided which receives medals paid out in accordance with the prize.

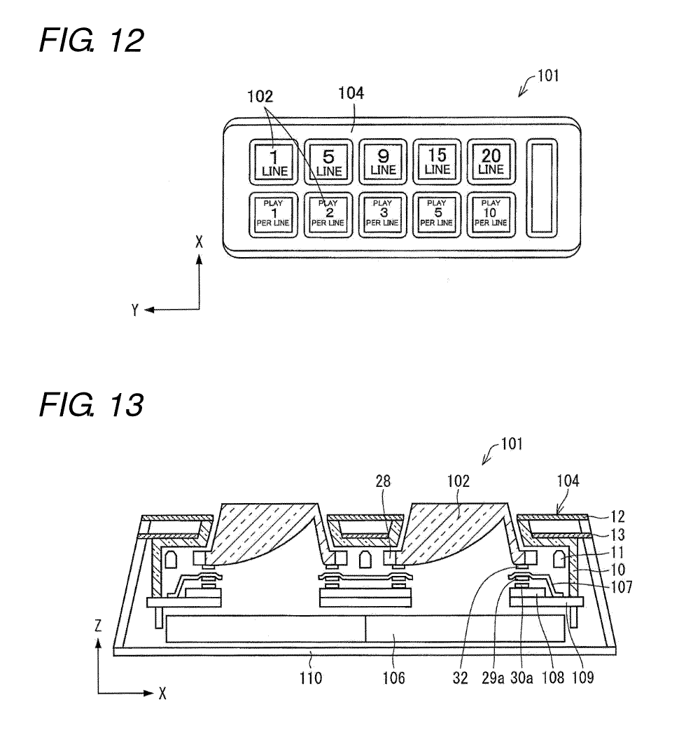

FIG. 12 shows a plan view of the switch unit 101, and FIG. 13 shows a sectional view of the switch unit 101. The switch unit 101 is provided with operation keys 102 for inputting the number of bets and the like.

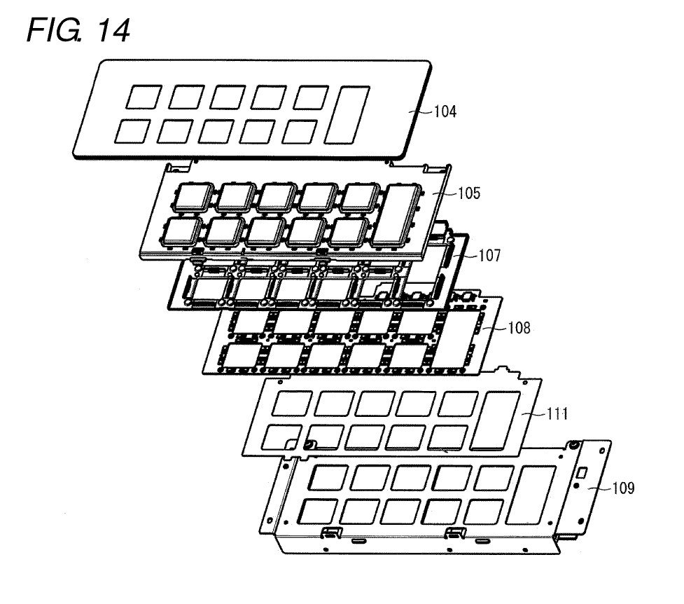

FIG. 14 is an exploded perspective view of the switch unit 101. As shown in FIG. 14, in the order from the top, the switch unit 101 includes a cover 104, an operation key plate 105, a rubber (elastic member) 107 to be the upper substrate (29) of the sheet switch, a PCB 108 to be the lower substrate (30) of the sheet switch, an insulating sheet 111, and a display portion case 109 configured to protect an image display portion 106. The operation key plate 105 is a plastic plate mounted with the operation keys 102, the light sauce 11, the light guiding portion 10 and the like which constitute the light performance device. It is to be noted that in FIG. 14, an image display portion, a base, screws and the like are omitted.

The cover 104, the rubber 107, the PCB 108, the insulating sheet 111 and the display portion case 109 are aligned with the position of the operation keys 102, and each have the same number of opening as the number of operation keys 102.

As shown in FIG. 14, the insulating sheet 111, the PCB 108, the rubber 107 and the operation key plate 105 are laminated on the display portion case 109, and the operation key plate 105 is joined with the display portion case 109. Subsequently, the cover 104 is superimposed on the operation key plate 105, and the cover 104 is fixed to the operation key plate 105. Finally, the image display portion 106 is placed on the base 110, and the base 110 and the cover 104 are fitted in a state where the image display portion 106 is held on the lower surface of the display portion case 109.

A contact 29a is provided on the lower surface of the rubber 107 as opposed to the leg piece 28 of the operation keys 102, and a contact 30a is provided on the upper surface of the PCB 108 as opposed to the contact 29a. Then, when the operation keys 102 is pushed, the rubber 107 is elastically transformed to push the contact 29a, and the contact 29a comes into contact with the contact 30a of the PCB 108.

In such a switch unit 101, with a plurality of operation keys 102 disposed on the same image display portion 106, the number of image display portion 106 to be used can be small, thus allowing the switch unit 101 to be inexpensive. Further, it is possible to reduce the thickness of the switch unit 101, so as to reduce the size of the switch unit 101.

Furthermore, by the operation keys 102 having the structure described in each of the first and second embodiments, an image displayed in the image display portion 106 looks floating to the top surface of the operation keys 102, while the operation keys 102 looks stereoscopic. This allows generation of a depth feeling in the entire switch panel made up of the switch unit 101.

The present invention is not restricted to the foregoing embodiments, but can be subjected to a variety of changes within the scope shown in the claims. That is, an embodiment which is obtained by combining technical means having been changed as appropriate within the scope shown in the claims, is also included in the technical scope of the present invention.

One or more embodiments of the present invention may be employed in game machines such as a slot machine, a poker game machine, a mah-jongg game machine and a card game machine.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A switch unit, comprising:
an operation key;
a cover member comprising an opening corresponding to the operation key; and
a light emitting device disposed on a rear surface side of the cover member that makes the periphery of the operation key luminous by irradiation with light from a light emitting portion disposed on the periphery of the operation key,
wherein a top surface side of the operation key is inserted from the rear surface side of the cover member into the opening,
wherein an opposing-mirror portion is disposed on the cover member on at least a peripheral part of the operation key,
wherein the opposing-mirror portion comprises a half-mirror portion and a mirror portion spaced apart from the half-mirror portion with a space therebetween,
wherein the half-mirror portion is disposed above the mirror portion,
wherein the light emitting portion of the light emitting device faces the space between the half-mirror portion and the mirror portion, and
wherein light emitted from the light emitting portion travels between the half-mirror portion and the mirror portion.

2. The switch unit according to claim 1,
wherein a transparent member is provided between the half-mirror portion and the mirror portion, and
wherein the light emitted from the light emitting portion travels inside the transparent member.

3. The switch unit according to claim 1,
wherein a display portion is provided on a rear surface side of the operation key,
wherein the operation key comprises an image see-through portion configured to transmit the image of the display portion therethrough, and
wherein the image see-through portion has a lens function of making the image of the display portion look as if displayed on the top surface of the operation key.

4. A game machine mounted with the switch unit according to claim 1.

5. The switch unit according to claim 2,
wherein a display portion is provided on a rear surface side of the operation key,
wherein the operation key comprises an image see-through portion configured to transmit the image of the display portion therethrough, and
wherein the image see-through portion has a lens function of making the image of the display portion look as if displayed on the top surface of the operation key.

6. A game machine mounted with the switch unit according to claim 2.

7. A game machine mounted with the switch unit according to claim 3.
